(19) United States
(12) Patent Application Publication
(10) Pub. No.: US 2018/0064509 A1
(43) Pub. Date: Mar. 8, 2018

(54) SELF-ILLUMINATION DENTAL HANDPIECE

(71) Applicant: TTBIO CORP., Taichung City (TW)

(72) Inventor: GENE SU, TAICHUNG CITY (TW)

(21) Appl. No.: 15/256,951

(22) Filed: Sep. 6, 2016

(51) Int. Cl. A61C 1/08; A61C 1/05; F04D 29/28; F04D 29/44; H02K 9/10; H02K 9/19; H02K 1/27; H02K 1/12; H02K 9/06; H02K 5/04

(52) U.S. Cl. CPC A61C 1/088; A61C 1/052; F04D 29/281; F04D 29/441; H02K 9/10; F05B 2220/706; H02K 1/2706; H02K 1/12; H02K 9/06; H02K 5/04; H02K 9/19

(57) ABSTRACT

A self-illumination dental handpiece includes a shell having a receiving space. The shell is assembled to a working room. An electricity-generation device is in the receiving space and includes first and second housings. A rotatable fan is in the second housing. The fan is coaxially connected to a magnet bar that is surrounded by a coil. The coil is electrically connected to a first conductive terminal engaged with a second conductive terminal, and the second conductive terminal is connected to a light-emitting device by a wire. A gas inlet pipe, a backflow pipe, a cooling-water pipe, and a cooling-gas pipe are in the receiving space. The pipes are positioned by a positioning member. The gas inlet pipe is connected to an external gas supply and the working room, and the backflow pipe is connected to the working room and the electricity generation device.

### BACKGROUND OF THE INVENTION

### Field of the Invention

The present invention relates to a dental handpiece, in particular to a dental handpiece having an electricity generation device so as to perform self electricity generation and self-illumination functions.

### Description of the Prior Art

Dentists need light for illumination during their therapies, and the light may come from a large lamp of a dental clinic unit or a small lamp of a dental handpiece. Some conventional dental clinic units do not have the power supplies for the small lamp of the dental handpiece, and the dental handpiece has to be connected to an external power supply. Therefore, the wires for connecting the dental handpiece with the external power supply may adversely affect the therapy. Nevertheless, buying a new dental clinic unit having a power supply for the small lamp of dental handpiece will generate an expensive cost.

A handpiece with an electricity generation device is developed, wherein the electricity generation device is driven by the gas flow used to drive the handpiece, and the handpiece can obtain electricity without connecting to the external power supply. However, such self electricity-generation handpiece has some disadvantages. Firstly, before arriving at the working portion of the handpiece to drive a dental tool, the gas flow has to pass through and drive the electricity generation device. As a result, the pressure of the gas flow will be reduced, resulting in that the dental tool cannot be driven in a stable manner, or even the pressure of the gas flow may be too weak to drive the dental tool. Second, since different pipes are assembled in a limited space of the handpiece without fastening, as well as the handpiece may generate oscillation during the use, the wire of the electricity generation device may break easily due to being pushed against the pipes, and the electricity generation device thus fails to provide electricity for driving the hand tool. Third, in the electricity generation device, a fan drives a magnet bar to rotate within a coil to generate electricity. However, the fan and the magnet bar are separated from each other and deflected respect to one another. As a result, the change of the magnetic flux within the coil is unstable, and the efficiency for electricity generation is bad.

### SUMMARY OF THE INVENTION

One object of the present invention is to provide a self-illumination dental handpiece which has an electricity generation device assembled therein, and the electricity generation device is driven by the gas flow which has already been used to drive the dental tool backflowed from the handpiece. Accordingly, the electricity generated by the electricity generation device can be provided for an LED lamp on the handpiece, so that a user can operate the handpiece conveniently.

In view of these, the self-illumination dental handpiece comprises a shell, an electricity generation device, a gas inlet pipe, a backflow pipe, a cooling water pipe, and a cooling gas pipe, and a positioning member. The shell forms a receiving space therein. One end of the shell is assembled to a working room, and a workpiece is assembled in the working room. The electricity generation device is assembled in the receiving space. The electricity generation device comprises a first housing and a second housing. The first housing encloses a first room. The second housing is assembled in the first room and spaced from the first housing by an interval. The second housing encloses a second room. The second housing comprises at least one via hole in communication with the first room and the second room. A fan which is rotatable is assembled in the second room, and the fan is coaxially connected to a magnet bar. A coil surrounds the magnet bar, and the coil is electrically connected to a first conductive terminal. The electricity generation device comprises a receptacle. The receptacle comprises a second conductive terminal. The second conductive terminal and the first conductive terminal are connected with each other by engagement, and the second conductive terminal is connected to a light emitting device by a wire. A gas inlet pipe is assembled in the receiving space. One of two ends of the gas inlet pipe is connected to an external gas supply, and the other end of the gas inlet pipe is connected to the working room. The backflow pipe is assembled in the receiving space. One of two ends of the backflow pipe is connected to the working room, and the other end of the backflow pipe is connected to the electricity generation device. The cooling water pipe and the cooling gas pipe are assembled in the receiving space. One ends of the cooling water pipe and the cooling gas pipe are respectively connected to an external water supply and the external gas supply, and the other ends of the cooling water pipe and the cooling gas pipe are connected to the working room. The positioning member is fixedly assembled in the receiving space. The positioning member comprises several through holes. The gas inlet pipe, the backflow pipe, the cooling water pipe, and the cooling gas pipe respectively pass through and positioned in the through holes.

In one embodiment, the turns of the coil is from 20 to 80, preferably from 35 to 45.

In one embodiment, the distance between the magnet bar and the coil is from 0.5 to 2 mm, preferably from 0.8 to 1.7 mm.

In one embodiment, the shell comprises an opening. The light emitting device passes through the opening from the receiving space and protruding out of the shell.

In one embodiment, the backflow pipe is a soft pipe.

### BRIEF DESCRIPTION OF THE DRAWINGS

FIG. 1 illustrates an exploded view of a self-illumination dental handpiece according to an exemplary embodiment of the present invention;

FIG. 2 illustrates an exploded view of an electricity generation device of the self-illumination dental handpiece;

FIG. 3 illustrates a sectional view of the electricity generation device of the self-illumination dental handpiece; and

FIG. 4 illustrates a partial perspective view of the self-illumination dental handpiece.

### DETAIL PORTIONED DESCRIPTION OF THE PREFERRED EMBODIMENTS

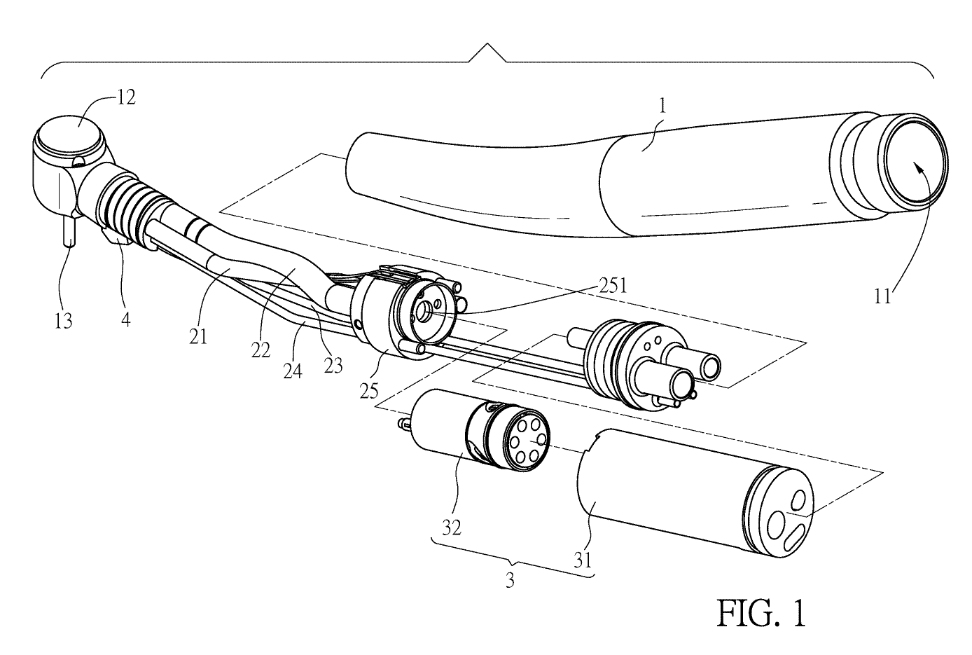

Please refer to FIG. 1, which illustrates a self-illumination dental handpiece according to an exemplary embodiment of present invention. The self-illumination dental handpiece comprises a shell 1 forming a receiving space 11 therein. One end of the shell 1 is assembled to a working room 12. A workpiece 13 is assembled in the working room 12. The workpiece 13 may be different kinds of dental tools driven by gas flows, and the dental tool can be removably assembled in the working room 12 according to different needs.

A gas inlet pipe 21, a backflow pipe 22, a cooling water pipe 23, and a cooling pipe 24 are assembled in the receiving space 11. In this embodiment, the backflow pipe 22 is a soft pipe. One of two ends of the gas inlet pipe 21 is connected to an external gas supply (not shown), and the other end of the gas inlet pipe 21 is connected to the working room 12 for guiding the high-pressure gas flow into the working room 12 to drive the workpiece 13. One of two ends of the backflow pipe 22 is connected to the working room 12 for guiding the rest gas flow from the working room 12 after the workpiece 13 is driven. One ends of the cooling water pipe 23 and the cooling gas pipe 24 are respectively connected to an external water supply and the external gas supply, and the other ends of the cooling water pipe 23 and the cooling gas pipe 24 are connected to the working room 12 for cooling the workpiece 13. A positioning member 25 is fixedly assembled in the receiving space 11. The positioning member 25 is positioned with the shell 1, so that the positioning member 25 is not moved with respect to the shell 1. The positioning member 25 comprises several through holes 251. The gas inlet pipe 21, the backflow pipe 22, the cooling water pipe 23, and the cooling gas pipe 24 respectively pass through and are positioned in the through holes 251. Accordingly, the pipes are stably positioned by the positioning member 25.

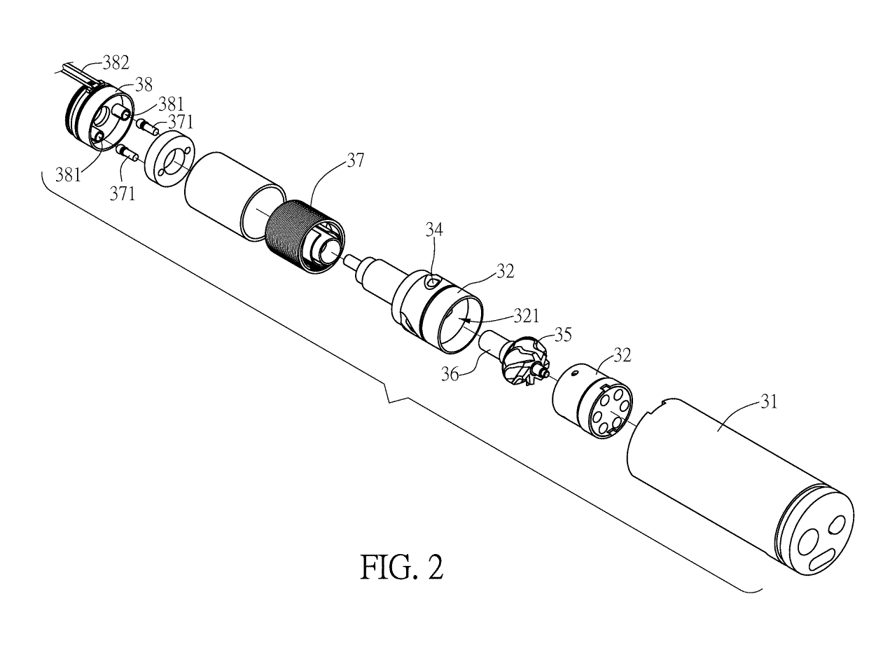

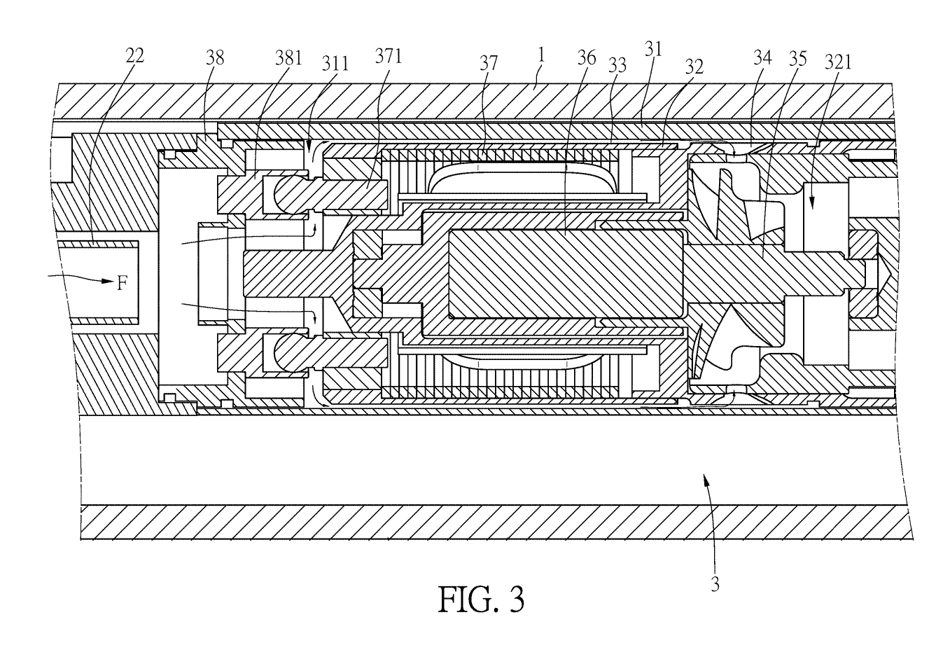

An electricity generation device 3 is assembled in the receiving space 11. As shown in FIGS. 2 and 3, the electricity generation device 3 comprises a first housing 31 enclosing a first room 311. The first housing 31 is connected to the backflow pipe 22, and the gas flow F backflowed from the working room 12 is entering the first room 311 accordingly. The first housing 31 comprises a second housing 32, and the second housing 32 is spaced from the first housing 31 by an interval 33. The second housing 32 encloses a second room 321, and the second housing 321 comprises at least one via hole 34 in communication with the first room 311 and the second room 321.

A fan 35 which is rotatable is assembled in the second room 321. In this embodiment, the position of the fan 35 corresponds to the position of the via hole 34. A magnet bar 36 is connected to the fan 35, and the axial center of the magnet bar 36 and the axial center of the fan 35 are aligned along the same axial line. A coil 37 surrounds an outer periphery of the magnet bar 36. In this embodiment, the turns of the magnet bar 36 is from 20 to 80, preferably from 35 to 45; a distance between the magnet bar 36 and the coil 37 is from 0.5 to 2 mm, preferably from 0.8 to 1.7 mm. The coil 37 is electrically connected to a first conductive terminal 371. The electricity generation device 3 comprises a receptacle 38, and the receptacle 38 comprises a second conductive terminal 381. The first conductive terminal 371 and the second conductive terminal 381 are male and female terminals and connected with each other by engagement. The second conductive terminal 381 is connected to a light emitting device 4 by a wire 382. In this embodiment, the light emitting device 4 is an LED lamp.

Accordingly, the gas flow out of the handpiece is guided into the working room 12 from the gas inlet pipe 22 to drive the workpiece 13. Next, as shown in FIG. 3, the gas flow is then entering into the electricity generation device 3 through the backflow pipe 22. The gas flow F passes through the interval 33 between the first housing 31 and the second housing 32 and enters into the second room 321 through the via hole 34 to rotate the fan 35. The magnet bar 36 is driven by the fan 35, so that the magnet bar 36 interacts with the coil 37 to perform an electromagnetic effect to generate electricity. Thereafter, the electricity is transmitted to the light emitting device 4 for illumination through the first conductive terminal 371, the second conductive terminal 381, and the wire 382.

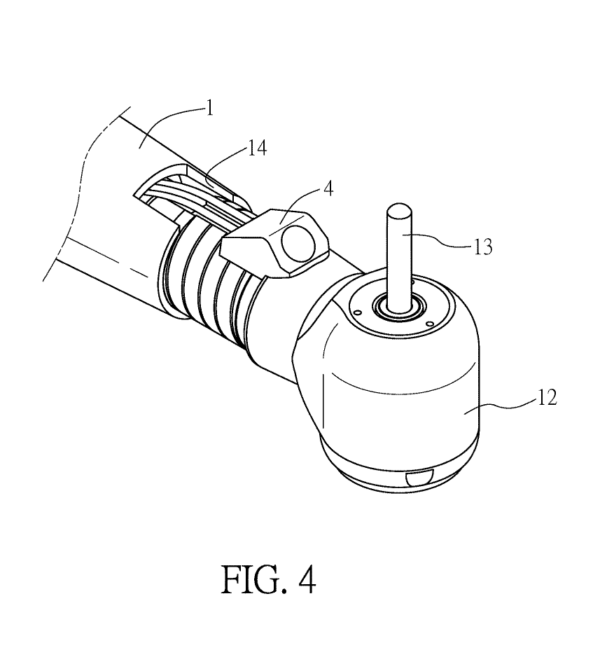

In this embodiment, as shown in FIG. 4, the light emitting device 4 is assembled in the one end of the receiving space 11 which is near to the working room 12. The light emitting device 4 is cubic shaped. On the other hand, the shell 1 comprises an opening 14 in rectangular shaped. The light emitting device 4 passes through the opening 14 from the receiving space 11 and protruding out of the shell 1. Accordingly, the shell 1 is blocked by the light emitting device 4 and cannot rotate relative to the working room 12. Therefore, a user can operate the handpiece stably.

The present invention has following advantages.

Firstly, the gas flow F used to drive the electricity generation device 3 is the gas flow that has been already used to drive the workpiece 13 and is the gas flow backflowed from the working room 12. Therefore, the driving efficiency and the power output of the workpiece 13 will not be affected.

Secondly, the pipes are positioned by the positioning member 25. Therefore, when the handpiece is in operation, the pipes are not abutted against each other. On the other hand, the electricity generation device 3 uses the two engaged conductive terminals 371, 381 to output electricity. The two conductive terminals 371, 381 can bear strong oscillation and would not be detached from each other during the operation of the handpiece.

Third, in the electricity generation device 4, the magnet bar 36 is coaxially connected to the fan 35. Therefore, when the magnet bar 36 is rotated in the coil 37, the change of the generated magnetic flux is stable, so that electricity can be provided for the use of the light emitting device 4.

Although particular embodiments of the invention have been described in detail for purposes of illustration, various modifications and enhancements may be made without departing from the spirit and scope of the invention. Accordingly, the invention is not to be limited except as by the appended claims.

1. A self-illumination dental handpiece, comprising:
a light emitting device;
a shell forming a receiving space therein, a working room disposed at and connected to one end of the shell, and a workpiece assembled in the working room;
an electricity generation device assembled in the receiving space of said shell and electrically couple to said light emitting device, the electricity generation device comprising a first housing having a first wall and a second housing having a second wall, the first housing enclosing a first room, and the second housing enclosing a second room, wherein the second housing is assembled in the first room with the second wall thereof radially spaced from the first wall of the first housing by an interval, wherein the second wall of said second housing is formed with at least one via hole, said first and second rooms of said first and second housings, respectively, being in communication through said at least one via hole;
a rotatable fan assembled in the second room of said second housing, said fan being coaxially connected to a magnet bar;
a coil surrounding the magnet bar and electrically connected to a first conductive terminal;
said electricity generation device comprising:
a receptacle,
first conductive terminals, and
second conductive terminals disposed in said receptacles,
wherein each of the second conductive terminals is connected with a respective one of said first conductive terminals through a socket engagement mechanism, and wherein said each second conductive terminal is connected to said light emitting device by a wire;
a gas inlet pipe assembled in the receiving space of said shell, wherein one of two ends of the gas inlet pipe is connected to an external gas supply, and the other end of the gas inlet pipe is connected to the working room;
a backflow pipe assembled in the receiving space of said shell, wherein one of two ends of the backflow pipe is connected to the working room, and the other end of the backflow pipe is connected to the electricity generation device;
a cooling water pipe and a cooling gas pipe assembled in the receiving space of said shell, wherein one end of each of the cooling water pipe and the cooling gas pipe is connected to an external water supply and the external gas supply, and the other end of said each of the cooling water pipe and the cooling gas pipe is connected to the working room; and
a positioning member fixedly assembled within the receiving space of said shell, wherein the positioning member comprises a cylindrically shaped wall and a crossing wall attached, along the periphery thereof, to said cylindrically shaped wall in crossing relationship thereto, said crossing wall being formed with a plurality of through holes, wherein each of the gas inlet pipe, the backflow pipe, the cooling water pipe, and the cooling gas pipe passes through a respective one of the through holes formed in said crossing wall and is supported in a predetermined position inside said shell by said positioning member.

2. The self-illumination dental handpiece according to claim 1, wherein the shell is formed with an opening, wherein the light emitting device passes through the opening from the receiving space of the shell to protrude external of the shell.

3. The self-illumination dental handpiece according to claim 1, wherein a number of turns of the coil ranges from 20 to 80.

4. The self-illumination dental handpiece according to claim 3, wherein the number of turns of the coil ranges from 35 to 45.

5. The self-illumination dental handpiece according to claim 1, wherein a distance between the magnet bar and the coil ranges from 0.5 to 2 mm.

6. The self-illumination dental handpiece according to claim 5, wherein the distance between the magnet bar and the coil ranges from 0.8 to 1.7 mm.

7. The self-illumination dental handpiece according to claim 1, wherein the backflow pipe is a soft pipe.
